(19) United States
(12) Patent Application Publication
(10) Pub. No.: US 2006/0081355 A1
(43) Pub. Date: Apr. 20, 2006

(54) System and method for regulating the heat management of a vehicle

(76) Inventors: Peter Horstmann, Leonberg (DE); Peter Satzger, Landsber am Lech (DE); Petra Kanters, Yokohama (JP); Manfred Schmitt, Heppenheim (DE); Karsten Mann, Stuttgart (DE); Oliver Kaefer, Murr (DE); Oliver Gerundt, Ammerbuch-Reusten (DE)

Correspondence Address: MICHAEL BEST & FRIEDRICH, LLP, 100 E WISCONSIN AVENUE, MILWAUKEE, WI, 53202, US

(21) Appl. No.: 10/526,263

(22) PCT Filed: Sep. 2, 2003
(86) PCT No.: PCT/DE03/02921

§ 371 Date: Mar. 2, 2005

(30) Foreign Application Priority Data
Sep. 4, 2002 (DE) 102 40 712.6

(51) Int. Cl. B60H 3/00; F01N 5/02

(52) U.S. Cl. 165/43; 165/51

(57) ABSTRACT

The invention relates to a system to regulate the heat balance of a vehicle, with a heat cycle that dissipates engine heat, which features a cooling circuit (38) and a heating circuit (36), through which circuits a coolant can flow, and with at least one component (20) of the vehicle producing waste heat, wherein a system is provided with which the waste heat of at least one component of the vehicle can be transferred to the heat cycle.

The present invention relates to a system to regulate the heat balance of a vehicle, with a heat cycle that dissipates engine heat, which features a cooling circuit and a heating circuit, through which circuits a coolant can flow, and at least one component of the vehicle producing waste heat. In addition, the invention relates to a method to regulate the heat balance of a motor vehicle.

### PRIOR ART

A combustion engine for a motor vehicle has a heat cycle, which can be subdivided into a cooling circuit and a heating circuit. The cooling circuit serves to dissipate engine heat into the ambient air and to cool the engine, wherein engine heat is first delivered to the cooling circuit to a therein circulating coolant, which is conveyed via a coolant pump to a cooling element of the cooling circuit. In this way, absorbed heat is released to the air flowing through the cooler. The heating circuit of the heat cycle through which the same coolant flows is used to heat the passenger compartment of the vehicle. The heating circuit features a heater heat exchanger with which the heat of the coolant is released to the ambient air flowing in the vehicle's passenger compartment. It is desirable when operating a combustion engine to reach high operating temperatures of the engine as quickly as possible in order to optimize the combustion that is occurring in the engine. As a result, emissions of pollutants can be reduced and exhaust gas limit values can be complied with. In this regard, in order to heat up the engine more quickly during the warm-up phase, a known method is circumventing the cooling element of the cooling circuit with a thermostat-regulated bypass line so that the coolant does not circulate through the cooling element until the thermostat opens based upon the engine reaching an operating temperature. In addition, it is particularly desirable in the case of cold outside temperatures to be able to use the waste heat of the engine as quickly as possible to warm up the engine. Since the heating capacity is low due to the reduced heat emission of the engine in its warm-up phase, integrating fuel-operated or electrically operated auxiliary heaters into the heat cycle, with which the air flowing in the vehicle's passenger compartment and/or coolant is heated, is known from the prior art.

### ADVANTAGES OF THE INVENTION

The system in accordance with the invention to regulate the heat balance of a vehicle builds on the generic prior art in that a system is provided with which the waste heat of at least one component of the vehicle can be transferred to the heat cycle.

The system to transfer the waste heat of a component of the vehicle can be a system with a housing, which makes it possible for coolant to flow around the parts of the component that are giving off waste heat. The waste heat of the component of the vehicle can be transferred via the heating circuit or the cooling circuit to the heat cycle. In the case of the system in accordance with the invention, a heat source of a component of the vehicle is incorporated into the heat cycle of the engine, whereby the coolant of the heat cycle can heat up more quickly. This produces both an accelerated heating up of the engine, which results in a reduction of fuel consumption and the emission of pollutants, as well as increased comfort for the vehicle passengers since the passenger compartment of the vehicle can be heated up more quickly due to the heat supply from the components of the vehicle and due to the quicker heating of the coolant. The latter also produces an increased standard of safety since quicker de-icing of the vehicle window is possible in the case of cold outside temperatures. In any case, realized in the system in accordance with the invention is that the heating capacity of a planned heater in the heat cycle of the engine does not depend only on the operating state of the engine heat cycle to heat up the passenger compartment of the vehicle, rather the opposite is true that said heating capacity contributes to the heating of the cooling circuit of the engine. In this regard, the auxiliary heater known from the prior art or an independent vehicle heater for the heating circuit of the heat cycle can be used in such a way that the coolant of the heat cycle is also heated in addition to heating the air fed into the passenger compartment of the vehicle. Thus, a well-balanced heat balance is realized in the motor vehicle particularly during the warm-up phase of the engine.

It must be emphasized in this connection that several components of the vehicle can be provided whose respective waste heat can be transferred to the heat cycle of the engine. Furthermore, additional systems that are known from the prior art and do not need to be discussed are provided to realize the heat transfer of a component of the vehicle. Thus, an additional coolant pump, for example, can be provided to circulate the coolant through the system planned in accordance with the invention. Furthermore, it must be emphasized that in general a transfer of the waste heat of a component can be prevented by a valve or blocking device if for example the engine has reached an adequate or specific operating temperature.

According to Claim 2, heat that is made available via the air conditioner cycle process is transferred via a refrigerant of the air conditioner through a coupling heat transfer medium to the coolant of the heat cycle of the engine. The heat transfer medium of the air conditioner can then be coupled in the process to the cooling circuit or the heating circuit of the heat cycle. Depending upon the type of design and control or regulation of the heat transfer medium of the air condition, additional valves such as mixing valves and control valves can be provided. In this regard, it is also possible to reverse the heat cycle of the air conditioner via planned air conditioner components in order to be able to use the air conditioner as a heat pump particularly in the case of low ambient temperatures, whereby the heat emitted by the heat pump is transferred in turn to the heat cycle of the engine in order to the heat the coolant that is circulating in it. As a result, this cycle can also be executed when the engine is at a standstill as an independent vehicle heater process. Due to the heating of the coolant, the temperature of the engine can be increased as a result before starting the combustion engine by the heated coolant being circulated through the engine. The result of this is that the engine heats up more quickly, thereby reducing emissions and fuel consumption from the moment the engine starts onward.

According to an advantageous embodiment, it is provided according to Claim 3 that the heat transfer medium of the air conditioner can be circumvented via a bypass line. As a result, temperature regulation is possible at the heat transfer medium, because the heat yield in the heat transfer medium can be varied via the returned heat quantity of the medium flowing though the heat transfer medium. The bypass line is preferably attached via at least one suitable valve, which can be used to completely or partially open or close it so that the rate of flow is adjustable.

Moreover, it is possible in accordance with an advantageous embodiment according to claim 4 to use the auxiliary heating device, which is provided to heat the ambient air flowing in the passenger compartment of the vehicle, to also heat the coolant.

The method in accordance with the invention to regulate the heat balance of a motor vehicle builds on the generic prior art in that the waste heat is transferred to the heat cycle by at least one component of the vehicle. The explanations with respect to the aforementioned system in accordance with the invention to regulate the heat balance of a motor vehicle should be read in the same or similar manner with respect to the method in accordance with the invention and the advantages referred to are transferable to it, whereby a repetitious discussion thereof is dispensed with in order to avoid redundancy.

The essential basic idea of the invention is to incorporate those types of components of the vehicle into the heat cycle of the engine, whose waste heat can be used to heat the coolant in order to contribute to the passenger compartment and the engine heating up more quickly.

### DRAWING

The invention will now be explained by way of example on the basis of preferred exemplary embodiments making reference to the enclosed drawing.

The drawing shows:

FIG. 1 A schematic representation of a heat cycle of a motor vehicle, in which a heat transfer medium of an air conditioner of a vehicle is incorporated at various positions, with which waste heat can be transferred to the heat cycle.

### DESCRIPTION OF THE EXEMPLARY EMBODIMENTS

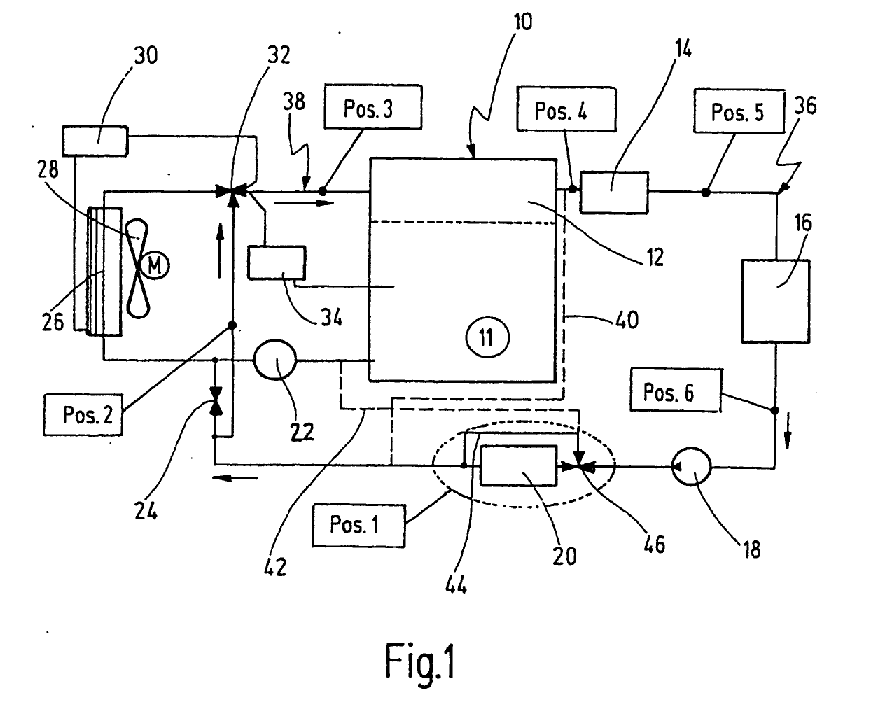

FIG. 1 shows a heat cycle of a combustion engine 10 of a motor vehicle. The heat cycle is used to regulate the operating temperature in an engine block 11 and a cylinder head 12 of the engine 10 as well as to regulate the temperature of the vehicle's passenger compartment. The heat cycle includes a cooling circuit 38, which leads from an engine block 11 of the engine 10 via a coolant or main water pump 22 and a cooling element 26 to the cylinder block 12 (there is a reverse pump direction in the cooling operation). Because of the main water pump 22, it is possible to circulate a coolant in 5 order release the heat transferred from the engine 10 to the coolant through the cooling element 26 to the ambient air. Flow-through of the cooling element with air that is required in the case of a standstill of the vehicle is also provided for via a cooling element fan 28. A bypass line to circumvent the cooling element is attached between valves 24, 32, which can be used to separate the cooling element branch in the case of cold engine temperatures in order to store the waste heat of the engine in coolant and increase the operating temperature of the engine with it as quickly as possible. The heating circuit 36 of the heat cycle leads from the cylinder head 12 of the engine 10 via an optional exhaust gas recirculation cooling element 14 to a heater heat exchanger 16 and via the main water pump 22 back to the engine 10. Because of the connection of the heating circuit 36 to the cooling circuit 38, only a single main water pump 22 is required. However, as shown in FIG. 1 an additional water pump 18 can be provided for the heating circuit 36 as an alternative. Furthermore, an oil heat exchanger 34 can be incorporated into the heat cycle of the engine 10. It is provided in accordance with the invention that at least one component of the vehicle be integrated into the heat cycle so that the waste heat from the component can be used to heat the coolant in the heat cycle.

According to FIG. 1, a coupling heat transfer medium 20 of an air conditioner of the vehicle is integrated into the heat cycle of the engine 10 in an exemplary manner and is used to accomplish a heat transfer of the waste heat generated by the air conditioner to the heat cycle of the engine. In order to heat up the passenger compartment in an optimal way, with a closed valve 24 and an open valve 38, the-coolant can first be pumped only through the additional water pump 18 directly into the cylinder head 12 and then into the heat cycle 36. As shown in FIG. 1, the heat transfer medium 20 can be integrated at various points in the heat cycle, i.e., both in the cooling circuit 38 as well as in the heating circuit 36 of the heat cycle. In this case, Position 1 through Position 6 indicate possible integration positions for the heat transfer medium 20. According to Position 1, the heat transfer medium 20 is integrated into the heating circuit 36 of the engine 10. A bypass line 44 around the heat transfer medium 20 is provided to regulate heat balance of the heat transfer medium 20. In this connection, the additional water pump 18 can also be provided in the flow direction behind the heat transfer medium 20 in accordance with Position 6. Based on this arrangement, heat from the air conditioner that is transferred through the heat transfer medium 20 to the heating circuit 36 is used to heat the engine first. Furthermore, it is possible to provide a bridge line 40 in the heating circuit 36, with which coolant can be directed via a heat transfer medium mixing valve (not shown) arranged in the flow direction behind the heat transfer medium 20 from the heat transfer medium 20 to the entrance of the exhaust gas recirculation cooling element 14. Thus, for example the heat transfer medium 20 can also be provided with a bypass line (not shown) in the bridge line 40.

The heat transfer medium mixing valve can be a proportional valve with two branches that can be throttled, for example. In addition, a short circuit line 42 can lead from the main water pump 22 to the entrance to the heat transfer medium 20, for example via a mixing valve. If a short circuit line 42 is provided, temperature regulation at the heat transfer medium is possible, whereby the bypass around the heat transfer medium 20 is no longer required. This short circuit line 42 can also be provided for the bridge line 40. In the case of integrating the heat transfer medium 20 into the bypass line of the cooling circuit 38 between the valves 24 and 32 in accordance with Position 2, there is no flow through the heat transfer medium 20 if the valve to the cooling element 26 is opened. However, it can then be assumed that the coolant is warm then and no auxiliary heating is desired. The heat can also be used for engine warm-up without the flow having to pass through the heating branch. In contrast, when the heat transfer medium 20 is integrated in accordance with Position 3, there is always flow through the heat transfer medium 20. In accordance with an integration of the heat transfer medium 20 at Position 4, the introduced heat is released with priority via the heater heat transfer medium 16 into the passenger compartment of the vehicle. The coolant entrance temperatures in the heat transfer medium 20 are higher in general at this position than at Position 1 through Position 3 and Position 6, whereby the temperature difference driving the heat transfer is smaller. In the case of integration of the heat transfer medium 20 in accordance with Position 5, the coolant entrance temperature in the heat transfer medium 20 is greater as compared with Position 1 through Position 4 and Position 6. This position makes possible the most direct possible coupling of the heat via the heater heat transfer medium into the passenger compartment of the vehicle.

Reference is again made to the fact that the flow directions illustrated by arrows in FIG. 1 are applicable for a switched-on supplementary coolant pump 18 and a closed valve 24.

The foregoing description of the exemplary embodiments according to the invention is for illustrative purposes only and not for the purposes of limiting the invention. Within the framework of the invention, various changes and modifications are possible without leaving the scope of the invention as well as their equivalents.

For example, the simple heater heat exchanger 16 shown in FIG. 1 can be replaced by a heater heat exchanger that is divided into two parts. This can also have a bypass. It is also possible to provide the heat transfer medium mixing valve as a simply designed valve in certain cases. In addition, it is possible to make parts of heat cycle shown in the figure optional or to arrange these at another location. As a result, the invention can also be realized on a heat cycle without an exhaust gas recirculation cooling element 14, or the compensation vessel 30 or the oil heat exchanger 34 is connected at another location of the heat cycle. Moreover, the mixing valve for the heat transfer medium 20 can be designed in such a way that the connected branch can be closed completely and one of the other branches is throttled. In addition, it is possible to drive and regulate or turn on or shut down the main water pump 22 and/or the additional water pump 18 electrically or by a mechanical output of the combustion engine.

1. System to regulate the heat balance of a vehicle, with
a heat cycle that dissipates engine heat, which features a cooling circuit (38) and a heating circuit (36), through which circuits a coolant can flow, and
at least one component (20) of the vehicle producing waste heat,
characterized in that a system is provided with which the waste heat of at least one component (20) of the vehicle can be transferred to the heat cycle.

2. System according to claim 1, characterized in that the entire engine is not integrated into the heat cycle, but predominantly the areas in which waste heat is produced, for example the combustion chambers and/or the Y-cooling, in particular in order to achieve a high temperature level more quickly during warm-up.

3. System according to claim 1, characterized in that the component producing the waste heat is a heat transfer medium (20) of an air conditioner, whose waste heat can be transferred to the heat cycle.

4. System according to claim 1, characterized in that a bypass line (44) is provided for the heat transfer medium (20).

5. System according to claim 1, characterized in that an auxiliary heating device is provided in the heating circuit (36) of the heat cycle, whose waste heat can be transferred to the heat cycle.

6. Method to regulate the heat balance of a vehicle, with
a heat cycle that dissipates engine heat, which features a cooling circuit (38) and a heating circuit (36), and
at least one component (20) of the vehicle producing waste,
characterized in that waste heat of the at least one component (20) of the vehicle is transferred to the heat cycle.

7. Method according to claim 6, characterized in that a supplementary coolant pump is provided, which in at least one operating mode pumps directly into a cylinder head, particularly in the case of an inactive main coolant pump.

8. System according to claim 2, characterized in that the component producing the waste heat is a heat transfer medium (20) of an air conditioner, whose waste heat can be transferred to the heat cycle.

9. System according to claim 2, characterized in that a bypass line (44) is provided for the heat transfer medium (20).

10. System according to claim 3, characterized in that a bypass line (44) is provided for the heat transfer medium (20).

11. System according to claim 2, characterized in that an auxiliary heating device is provided in the heating circuit (36) of the heat cycle, whose waste heat can be transferred to the heat cycle.

12. System according to claim 3, characterized in that an auxiliary heating device is provided in the heating circuit (36) of the heat cycle, whose waste heat can be transferred to the heat cycle.

13. System according to claim 4, characterized in that an auxiliary heating device is provided in the heating circuit (36) of the heat cycle, whose waste heat can be transferred to the heat cycle.

14. Method according to claim 6, characterized in that the entire engine is not integrated into the heat cycle, but predominantly the areas in which waste heat is produced, for example the combustion chambers and/or the Y-cooling, in particular in order to achieve a high temperature level more quickly during warm-up.

15. Method according to claim 6, characterized in that the component producing the waste heat is a heat transfer medium (20) of an air conditioner, whose waste heat can be transferred to the heat cycle.

16. Method according to claim 6, characterized in that a bypass line (44) is provided for the heat transfer medium (20).

17. Method according to claim 6, characterized in that an auxiliary heating device is provided in the heating circuit (36) of the heat cycle, whose waste heat can be transferred to the heat cycle.
